(19) United States
(12) Patent Application Publication
(10) Pub. No.: US 2020/0155411 A1
(43) Pub. Date: May 21, 2020

(54) VIBRATORY MODULE

(71) Applicant: AMERICAN LATEX CORP., Chatsworth, CA (US)

(72) Inventor: Calvin Spencer Lee, Northridge, CA (US)

(73) Assignee: American Latex Corp., Chatsworth, CA (US)

(21) Appl. No.: 16/289,463

(22) Filed: Feb. 28, 2019

Related U.S. Application Data
(60) Provisional application No. 62/768,807, filed on Nov. 16, 2018.

(51) Int. Cl. A61H 23/02; B06B 1/02; B06B 1/04; A61H 19/00

(52) U.S. Cl. CPC A61H 23/0218; B06B 1/0215; A61H 2201/14; A61H 19/00; A61H 2201/0153; B06B 1/045

(57) ABSTRACT

A vibrating apparatus including a body; a shaft and a hub disposed in the body with the hub connected to the shaft; and a resilient member coupled to the shaft. The hub is operable to rotate in a first direction in response to an electrical signal with such rotation operable to generate a load on the resilient member and to rotate in a second direction when the load is released. A vibrator including a vibrating apparatus in a housing. A method for vibrating an apparatus using pulse-width modulation including generating pulses to cause a hub coupled to a shaft in a body of the apparatus to rotate the shaft in a first direction; and changing a direction of rotation of the shaft to a second direction between pulses, wherein a duty factor of a pulse width and pulse spacing is selected to cause the apparatus to vibrate.

### CROSS-REFERENCE TO RELATED APPLICATIONS

This application claims the benefit of U.S. Provisional Patent Application No. 62/768,807 titled “Vibratory Module,” filed Nov. 16, 2018, the contents of which are incorporated herein by reference in their entirety.

### TECHNICAL FIELD

A vibrating apparatus, a vibrator and a method of vibrating an apparatus using pulse-width modulation in the absence of an eccentric weight or mass.

### BACKGROUND

Vibrators often generate their vibrations using eccentric rotating weights or masses driven by a motor, such as an electric motor. The weight may be connected to a shaft that rotates under the power of the motor. The weight is eccentric in the sense that it may not have a similar axis of rotation as the shaft. As the weight rotates with the rotation of the shaft, the force of the offset weight becomes asymmetric. This results in a net centrifugal force, which causes the motor to become displaced. As it rapidly spins, the motor is constantly displaced, which creates vibrations. The constant displacement of the motor in this manner also creates noise.

Hand-held vibrators may be used as massage devices with the vibrations produced used to massage muscles of a body (e.g., a human body). In addition to massage applications, other medical applications of vibrators include, but are not limited to vibration alerting or haptic feedback devices for uses such as taking a temperature of a patient, diabetes screening, alerting a user in a potentially noisy environment or alerting a user on wards where other patients may be asleep. Hand-held vibrators can also be used in neuropathological applications with vibrations used to test a patient's response to varying levels of touch. Hand-held vibrators may also be used to stimulate erogenous zones such as the clitoris, the vulva or vagina, penis, scrotum or anus. Other haptic feedback uses of hand-held vibrators include, but are not limited to video games (e.g., joysticks) and smartphones Other haptic applications for vibrators include in automobile applications such as vibrating alerting systems in steering wheels and tactile feedback in touch screen displays.

### SUMMARY

The invention is a vibrating apparatus including a body; a shaft disposed in the body; a hub disposed in the body and coupled to the shaft; and a resilient member coupled to the shaft. The hub is operable to rotate in a first direction in response to an electrical signal with such rotation operable to generate a load on the resilient member and to rotate in a second direction when the load is released.

The invention is also a vibrator including a housing such as a housing that may be held in a single human hand (hand-held) and a vibrating apparatus disposed in the housing. The vibrating apparatus includes a body; a shaft disposed in the body; a hub disposed in the body and connected to the shaft; and a resilient member coupled to the shaft. The vibrator also includes a controller disposed in the housing and electrically connected to the hub. The controller is operable to generate to a duty factor of a pulse width (on state) and a pulse spacing (off state) to power the hub in an on state and rotate the shaft about a longitudinal axis in a first direction and the resilient member is operable to rotate the shaft in a second direction opposite the first direction when the hub is in an off state between pulse widths. The duty factor is selected to cause the body to vibrate.

The invention is further a method for vibrating an apparatus using pulse-width modulation. The method includes generating pulses to cause a hub coupled to a shaft in a body of the apparatus to rotate the shaft in a first direction; and changing a direction of rotation of the shaft to a second direction between pulses. A duty factor of a pulse width (on state) and pulse spacing (off state) is selected to cause the apparatus to vibrate.

### BRIEF DESCRIPTION OF THE DRAWINGS

These and other features, aspects and advantages of the present invention will become better understood with regard to the following description, appended claims, and accompanying figures where:

FIG. 1 shows a hand-held massage device including a vibrating apparatus or device;

FIG. 2 shows a cross-section of FIG. 1 through line 2-2′;

FIG. 3 shows a cross-section of FIG. 2 through line 3-3′;

FIG. 4 shows a cross-section of FIG. 3 through line 4-4′;

FIG. 5 shows a cross-section of FIG. 3 through line 5-5′;

FIG. 6 shows a cross-section of FIG. 3 through line 6-6′;

FIG. 7 shows an interaction between an electrical coil and permanent magnets of a vibrating device when the coil is powered to rotate in a first direction;

FIG. 8 shows an interaction between an electrical coil and permanent magnets of a vibrating device when the coil is powered to rotate in a second direction;

FIG. 9 shows pulse width modulation square wave signals for half and full cycle modulation; and

FIG. 10 shows operation signals of a vibrating device that operates at a single current frequency and modifies a vibration frequency through a change in a duty cycle of the current frequency.

### DETAILED DESCRIPTION

A vibrating apparatus is described. The vibrating apparatus may use pulse width modulation to control signals to cause the apparatus or device to vibrate in the absence of an eccentric weight or mass. A vibrating apparatus or device may a body; a shaft disposed in the body; a hub disposed in the body and connected to the shaft; and a resilient member connected to the shaft. The hub may be operable to rotate the shaft in a first direction in response to an electrical signal. Such rotation may be less than 360 degrees, such as 180 degrees or less, or 150 degrees or less depending on a pulse length of the electrical signal. The rotation in the first direction generates a load on the resilient member. In the absence of an electrical signal, the load on the resilient member is released which causes the shaft to rotate in a second direction opposite the first direction.

The vibrating apparatus may be a component of a vibrator including a housing containing the vibrating apparatus or device. The vibrator may be a hand-held vibrator suitable for use as a massage device or a medical application or non-medical alert or haptic feedback application. The housing of the vibrator may include a controller that is connected to the hub and operable to generate to a duty factor of pulse width (on state) and pulse spacing (off state) to power the hub in an on state and rotate the shaft about a longitudinal axis in a first direction. The resilient member that is connected to the shaft is operable to rotate the shaft in a second direction opposite the first direction when the hub is in an off state between pulse widths. The duty factor or pulse width modulation frequency of pulse width (on state) and pulse spacing (off state) is selected to cause the body to vibrate through the repeated rotation (caused by a current pulse to the hub) and return (caused by the resilient member) of the shaft. Since the vibration is a result of high frequency pulsing (e.g., frequencies on the order of 100 hertz (Hz) or more, such as 100 Hz to 150 Hz) without an eccentric weight being present, the device does not generate the noise associated with eccentric weight-based vibrators.

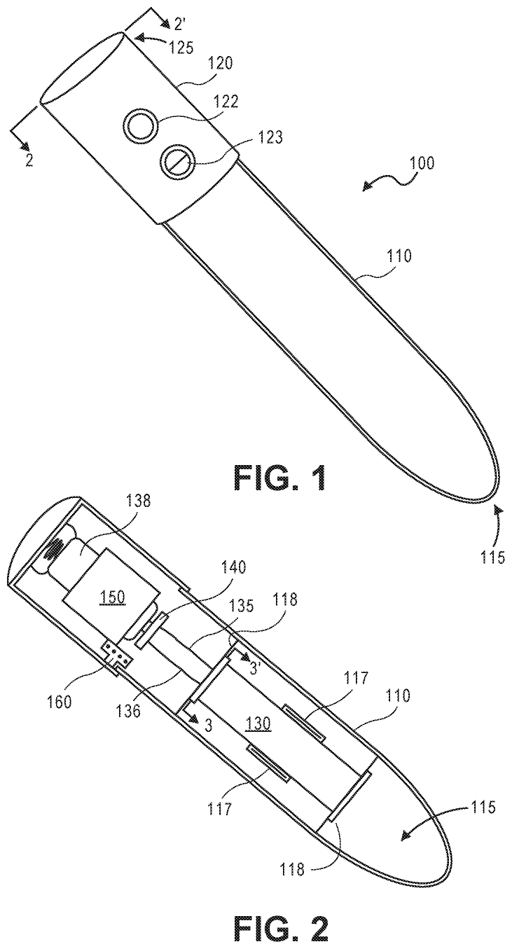

FIG. 1 illustrates a vibrator that may be a massage device including a vibrating apparatus or device. In this example, the vibrator may be used to massage muscles or stimulate erogenous zones of a body (e.g., a human body). Device 100 includes housing 110 including an outer surface of a generally cylindrical shape having opposite first end portion 115 and second end portion 120, the first end portion being defined by a spherical or dome shape (a spherical or dome shaped end), the second end being defined by a flat circular shape. Housing 110 may be a rigid, durable material such as a metal (e.g., aluminum alloy, stainless steel) or a polymer (e.g., a polythene (e.g., high density polyethylene)). Housing 110 may be a multiple layer or component housing with, for example, a hard, durable material overlaid by a soft polymer such as a silica gel material. Housing 110 may be single structure (unitary body from end to end) or be made of multiple structure portions. Housing 110 as a hand-held device may have a length on the order of 15 centimeters (cm) to 35 cm and a diameter or 3 cm to 6 cm.

Positioned on or in a surface of device 100 near second end portion 120 is switch 122 and switch 123. Switch 122 may be connected to or part of an on/off actuator. Representatively, switch 122 may be a button that is pushed/pressed inward to turn the device on and when the device is on, switch 122 may be pushed/pressed inward to turn the device off. Switch 123 may be connected to a controller within a volume of housing 110 that controls a duty factor or pulse width modulation frequency of a hub also within the volume of the housing. Representatively, switch 123 is a rocker switch that when pressed at one end increases a duty factor and when pressed at an opposite end decreases a duty factor.

FIG. 2 shows a cross-section side view of the device of FIG. 1 through line 2-2′. FIG. 2 shows a volume within housing 110 and components or devices with the volume. Referring to FIG. 2, disposed with a volume of housing 110 of device 100 is vibrating apparatus or device 130. Vibrating device 130 may be a generally cylindrical structure having a length on the order of 6 cm or smaller (e.g., 4 cm length, 3 cm length or 2 cm length) and a diameter on the order of 2 cm or smaller (e.g., 1 cm diameter). Vibrating device 130 may have a length that is on the order of one tenth a length of housing 110. Vibrating device 30 may be positioned at or near first end portion 115 of housing 110, such as within 5 cm of the end of the housing. Vibrating device 130 may be positioned longitudinally within a volume of housing 110 and is secured in the housing and connected thereto by tabs or walls 117 on opposing sides of vibrating device 130 and tabs or walls 118 on opposing ends of the vibrating device 130. FIG. 2 shows electrical conductor 135 and electrical conductor 136 (e.g., electrically conductive wire) extending from one end of vibrating device 130 and representatively through wall or tab 118. At least one of electrical conductor 135 is connected to electrical interface 140 disposed within a volume of housing near second end portion 120. One of electrical conductor 135 and electrical conductor 136 may be connected to a positive (+) pole at electrical interface 140 and the other to a negative (−) pole at electrical interface. The designation of the positive and negative pole may change during the operation of the device, such as through direction of controller 150.

FIG. 2 also shows power source 138 that may be a battery (e.g., a direct current (DC) battery that may be a rechargeable battery (e.g., a lithium battery, a nickel metal hydride (NiMH) battery)) disposed within a volume of housing 110. Power source 138 may be positioned at or near second end portion 120 of housing 110. Power source 138 such as a battery may be connected to electrical interface 140. A representative battery may be a lithium polymer rechargeable battery, such as a 3.7 volt, 260 milliamp hour capacity battery. Another representative battery is an AA or AAA battery. Housing 110 may accommodate more than one battery as a power source, such as two AA or AAA batteries side by side or arranged end to end. Disposed over power source 138 in FIG. 2 is controller 150. Controller 150 may be, for example, a printed circuit board including a circuit or circuits operable to or configured to control a hub or rotor in response to actuations of switch 123. In one embodiment, controller 150 may be operable to generate a duty factor or pulse width modulation frequency of pulse width (on state) and pulse spacing (off state) to vibrating device 130 (e.g., a hub or rotor within vibrating device 130). FIG. 2 further shows power source charging circuit 160 disposed in a volume of housing 110 of device 100. Power source charging circuit 160 may be connected at one end to electrical interface 140 and has a female receptacle extending to an outer surface of housing 110 operable to allow a charging device to be inserted therein to charge power source 138 from an external power supply where power source 138 is rechargeable, such as a lithium battery or a NiMH battery. Housing 11 may be accessible at one end such as at second end portion 125 to allow access to power source 138. An end of second end portion 125 of housing 110 may be, for example, a cap that mates with the body of the housing through a force fit or threaded connection. In another example, the power source may be an external power source, such as through an electrical outlet in a building (e.g., a home). In such case, the power source may be connected to a power cord including a converter (alternating current to direct current converter) and the power cord connected to housing 110 through power source charging circuit 160.

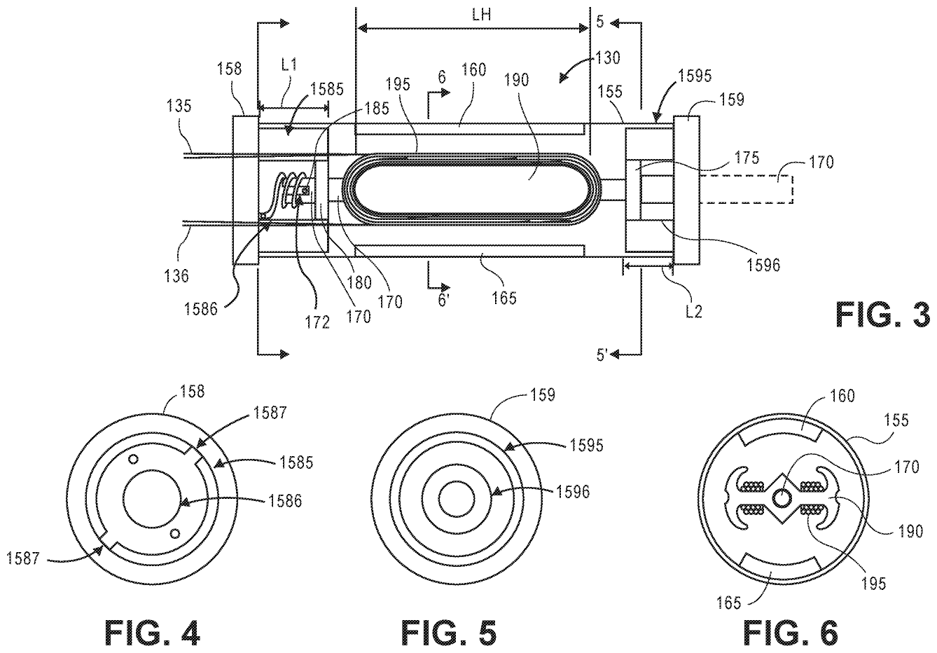

FIG. 3 shows a cross-section side view of vibrating apparatus or device 130 that is disposed in housing 110 of device 100. FIG. 3 is a cross-section through line 3-3′ of FIG. 2. Vibrating device 130, in this example, includes cylindrical casing 155 having opposing open end portions with caps or covers (cover 158 and cover 159) disposed in respective open end portions of casing 155. Casing 155 may be rigid material such as a metal (e.g., steel, aluminum alloy). Cover 158 and cover 159 may also each be a rigid material such as a metal or plastic material (e.g., a polythene). Cover 158 and cover 159 may have cylindrical ends that have a diameter larger than an inner diameter of casing 155. Cover 158 includes sleeve 1585 and cover 159 includes sleeve 1595. Each of sleeve 1585 and sleeve 1595 has an outer diameter smaller than an inner diameter of casing 155 so that each sleeve can be positioned within a volume of casing 155 by, for example, a force fit. FIG. 4 shows a cross-section through line 4-4′ of FIG. 3 and FIG. 5 shows a cross-section through line 5-5′ through FIG. 3 to illustrate sleeve 1585 of cover 158 and sleeve 1595 of cover 159 with components in each sleeve removed to illustrate the sleeve.

Disposed within a volume of casing 155 is axle or shaft 170. Shaft 170 may be a solid material having a cylindrical shape. One suitable material for shaft is a metal material such as stainless steel. Shaft 170 extends through a center of casing 155 with opposing ends disposed in a portion of a sleeve of cover 158 and cover 159. Disposed near first end of shaft 170 is bearing 175 such as a bushing or other type of bearing and near an opposite second end is bearing 180 such as a ball bearing or other type of bearing. Each of bearing 175 and bearing 180 may be disposed around shaft 170. As illustrated in FIG. 3 and FIG. 4, sleeve 1585 of cover 158 includes opening 1586 having a diameter to accommodate bearing 180 disposed on shaft 170 so that each of the shaft and bearing are disposed within opening 1586. Sleeve 1595 of cover 159 as shown in FIG. 3 and FIG. 5, includes opening 1596 having a diameter to accommodate each of shaft 170 and bearing 175 disposed on shaft 170 and shaft 170 may extend beyond bearing 175 into opening 1596. Sleeve 1595 may have a length, L2, that is less than a length, L1, of sleeve 1585. Sleeve 1585 and sleeve 1595 and respective bearings (bearing 175 and bearing 180) on shaft 170 may limit the movement of shaft 170 to rotational movement and resist or inhibit axial movement.

FIG. 3 also shows shaft 175 having longitudinally-disposed slot 172 on second end. Disposed in slot 172 is one end of spring 185. Spring 185 is disposed in opening 1586 of sleeve 1585 of cover 158 and may wrap in a coil around a portion of shaft 172 at the second end of the shaft. Spring 185 has a length that extends beyond an end of shaft 175 into opening 1586 of sleeve 1585. Sleeve 1585 may have one or more notch 1587 therein into which a second end of spring 185 is positioned to secure spring 185 in cover 158. A second end of spring may extend tangentially from the coil allowing the second end to be slidably placed within notch 1587 of sleeve 1585. While a spring is illustrated connected to shaft 172 and cover 158, other resilient members are suitable (e.g., an elastic band).

In FIG. 3, shaft 175 is disposed within or inside vibrating apparatus or device 130 (within casing 155, cover 158 and cover 159). In another example, shaft 175 may extend from one end of vibrating apparatus or device 130 such as protrude through cover 159 and extend a distance from the cover. In this manner, a device may be connected to shaft 175 outside the casing and covers.

FIG. 3 further shows hub 190 positioned on shaft 170 in a central portion of a volume of casing 155. Hub 190 may be a solid structure of, for example, a steel/silicon laminate such as electrical steel. Hub 190 has a winged shape with a central opening connected to shaft 170 so that rotation of the hub 190 will rotate shaft. The winged shape may include opposing extending arms terminated by crescent shaped wings. FIG. 6 shows a cross-section through line 6-6′ and illustrates this example of a shape of hub 190. Hub 190 including its opposing arms may have a length, LH, that is at least one-half the length of casing 155 and is positioned within casing 155 between sleeve 1585 of cover 158 and sleeve 1595 of cover 159 (e.g., in the middle of casing 155). Hub 190 has a winged shape with a central opening connected to shaft 170 so that rotation of the hub 190 will rotate shaft. Wrapped around the arms of hub 190 in multiple wraps or windings may be an electrical coil or coils 195 such as bare copper wire or wires (electrically conductive wire). Coil 195 may be a single length of copper wire that is wrapped in one direction on one arm and another direction on another arm of hub 190. The different directions of the wrapping provides different magnetic fields with a pulse width modulation. The assembly of hub 190 connected to shaft 170 and coil 195 may describe a rotor of an electric motor. Two ends of coil 195 represented as electrical wire 135 and electrical wire 136 extend from coil 195 through openings in cover 158 and are connected to interface 140 to draw current from power source 138 in housing 110 of device 100 (see FIG. 2).

FIG. 3 still further shows permanent magnet 160 and permanent magnet 165 each connected to an inner wall of casing 155 with one magnet opposing the other magnet. Each of magnet 160 and magnet 165 may be connected to an inner wall by an adhesive or a force fit. One of magnet 160 and magnet 165 may be designated north (“N”) and the other of magnet 160 and magnet 165 south (“S”). Magnets 160 and 165 may have a length approximating the length of hub 190. FIG. 6 shows a cross-section through line 6-6′ of FIG. 3 and shows the illustrating opposing magnets 160 and 165.

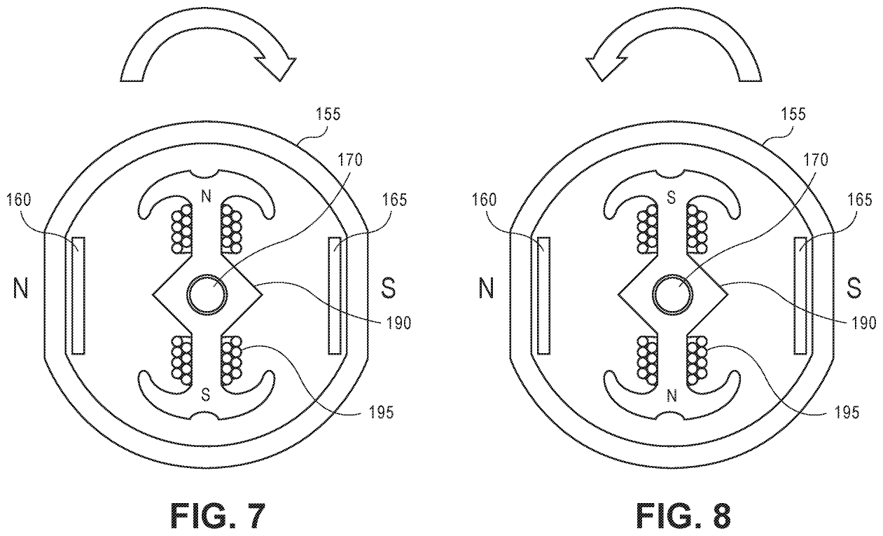

FIG. 7 illustrates an interaction between electrical coil or coils 195 and permanent magnets 160 and 165 inside casing 155. When switch 122 (see FIG. 1) is switched on to power the device (see FIG. 1), controller 150 generates high frequency pulses that pass through electrical coil 195 to generate a magnetic field. The magnetic field generated by the electrical coil 195 interacts with the magnetic field produced by permanent magnet 160 and permanent magnet 165. The result is a rotation of the shaft 170 in response to a pulse (pulse on state). The length of a pulse on state effects the amount of rotation. The direction of rotation depends on whether lead 135 or lead 136 to coil 195 is connected to the load. Representatively, FIG. 7 shows when lead 135 is connected to positive (+) and lead 136 is connected to negative (−). In such case, a top of hub 190 as viewed will be magnetically north (N) and a bottom of hub 190 magnetically south (S) and the hub 190 will rotate clockwise. Alternatively, when lead 136 is connected to positive (+) and lead 135 is connected to negative (−), a top of hub 190 will be magnetically south (S) and a bottom of hub 190 magnetically north (N) and the hub 190 will rotate counterclockwise as illustrated in FIG. 8.

As noted above, when switch 122 is switched on to power the device, controller 150 generates high frequency pulses that pass current from power source 186 through electrical coil 195 to generate a magnetic field. The magnetic field generated by the electrical coil 195 interacts with the magnetic field produced by permanent magnet 160 and permanent magnet 165. The result is a rotation of the hub 190 and shaft 170 in response to a pulse (pulse on state). The confinement of shaft 170 and hub 190 in casing 155 or within or by cover 158 and cover 159 may limit the movement of each to rotation only and exclude axial movement. The length of a pulse on state effects the amount of rotation. A rotation of shaft 170 may be less than a complete rotation (less than 360 degrees). A rotation of the shaft 170 in response to a pulse (pulse on) may be 180 degrees or less, such as 150 degrees or less (e.g. 145 degrees, 130 degrees, 100 degrees, 90 degrees). Since shaft 170 is connected to a resilient member such as spring 185, rotating shaft 170 generates a load on the resilient member (on spring 185). When the pulse is terminated (pulse off state), the resilient member releases the load causing shaft 170 to rotate in an opposite direction. Repeated pulsing (on state) and pulse spacing (off state) at high frequency causes vibrating apparatus or device 130 to vibrate. Since vibrating device 130 is connected to housing 100 of vibrator 100, the vibration of vibrating device 130 is passed on to massage device 100 and vibrator 100 vibrates. A vibration frequency may be controlled by switch 123 such as by pushing the switch down at one end to increase the frequency and down at an opposite end to reduce the frequency. Vibrating device 130 allows high current frequency pulsing (e.g., frequencies on the order of 100 hertz (Hz) to 150 Hz (e.g., 110 Hz, 120 Hz, 125 Hz or more) that is not constrained by an eccentric weight connected to shaft 172. The high frequency operation provides vibration with reduced noise relative to eccentric weight-based vibration devices. The duty factor or the current frequency of the pulsing (pulse on) is controlled by controller 150 and by a user directing the controller through switch 123. This allows a user to modify the duty factor or current frequency while the device is in operation to modify a vibration (vibration frequency) of the vibrating device.

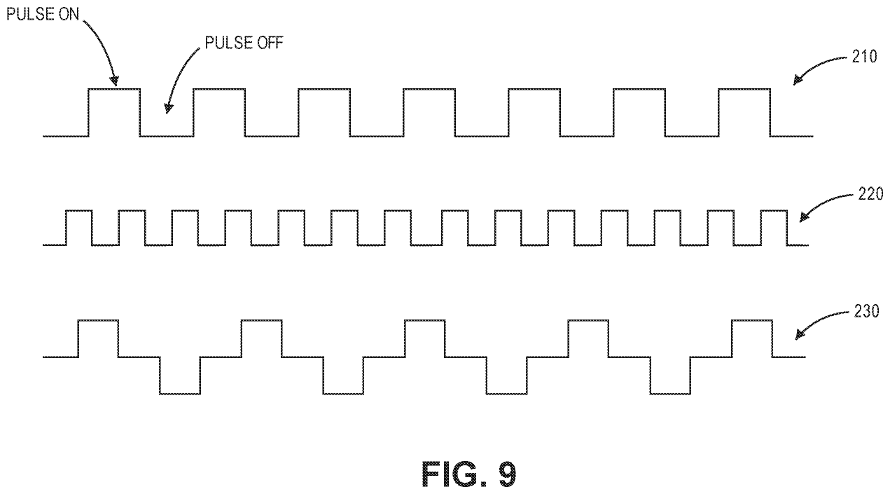

In one example, a rotation of the shaft 170 in response to a high frequency pulse (pulse on) from power source 138 to coil or coils 195 is a rotation of 180 degrees or less. In one example, the rotation is in one direction (e.g., clockwise) with one of lead 135 and lead 136 successively being designated the positive lead. This describes a half-cycle operation and is illustrated in square wave 210 in FIG. 9. Square wave 220 in FIG. 9 illustrates the pulse width modulation signal when the frequency is increased relative to the frequency in square wave 210. In another example, the rotation from one direction (clockwise) to another direction (counterclockwise) may alternate, such as on successive pulses (successive pulse on). This describes a full cycle operation and is illustrated in square wave 230 in FIG. 9. In full cycle operation, the positive lead switches between lead 135 and lead 136 with each successive pulse.

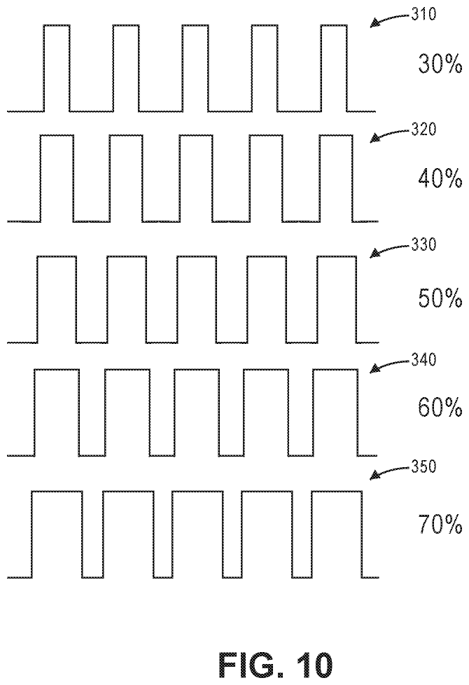

FIG. 10 shows operation signals of a vibrating device that operates at a single current frequency and modifies a vibration frequency through a change in a duty cycle of the current frequency. In FIG. 10, a current frequency is, for example, 150 Hz. The duty cycle may be established in controller 150 (FIG. 2) according to five preset duty cycles (e.g., 30 percent, 40 percent, 50 percent, 60 percent and 70 percent). The duty cycle may be individually selected by a user control of switch 123 (FIG. 1). When vibrating device 100 is powered on, the device may operate at a duty cycle of 30 percent as shown by signal 310 as a first preset in controller 150. Switch 123 is pressed and controller 150 provides pulses from power source 138 that pass through electrical coil 195 at a frequency of 150 Hz and a duty cycle of 30 percent. The 30 percent duty cycle provides the lowest vibration frequency of the device in this example. A user of vibrating device 100 may increase the duty cycle and the corresponding vibration frequency by pressing switch 123. Pressing switch 123 once modifies the duty cycle from 30 percent to 40 percent (signal 320); pressing twice modifies the duty cycle from 40 percent to 50 percent (signal 330); pressing three times modifies the duty cycle from 50 percent to 60 percent (signal 340); and pressing four times modifies the duty cycle from 60 percent to 70 percent (signal 350). In this example, a current frequency of 150 Hz operating at a duty cycle of 70 percent (signal 350) produces a greater vibration frequency than a current frequency of 150 Hz operating at a duty cycle of 30 percent (signal 310).

In another example, a vibration frequency of vibrating device 100 may be modified through a change in current frequency. Controller 150 may have presets of five different frequencies (100 Hz, 150 Hz, 200 Hz, 250 Hz and 300 Hz) with each at a duty cycle (e.g., 50 percent duty cycle). A current frequency may be individually selected by a user control of switch 123. In this example, a current frequency of 300 Hz produces the greatest vibration frequency (300 Hz>250 Hz>200 Hz>150 Hz>100 Hz). In a further example, a vibration frequency of vibrating device 100 may be modified through a change in current frequency and duty cycle. For example, controller 150 may have presets of two different frequencies (150 Hz and 200 Hz) and presets of duty cycles for each of the two different frequencies such as presets to operate each of the different frequencies at a duty cycle of 50 percent, 60 percent or 70 percent.

Although FIGS. 1-8 describe a hand-held vibrator suitable as a massage device, it should be appreciated that the pulse width modulation vibrating device may be used in other applications. These include, for example, other medical applications employing vibrating devices such as alerting devices or haptic feedback devices and non-medical applications such as in video games (e.g., joysticks), smartphones and automobile applications (e.g., vibrating alerting systems in steering wheels and tactile feedback in touch screen displays).

1. A vibrating apparatus comprising:
a body;
a shaft disposed in the body;
a hub disposed in the body and coupled to the shaft;
a resilient member coupled to the shaft;
a direct current power source; and
a controller coupled to the power source and operable to generate a duty cycle of a pulse width and a pulse spacing,
wherein the hub is operable to rotate in a first direction in response to a pulse having the pulse width with such rotation operable to generate a load on the resilient member and to rotate in a second direction when the load is released,
wherein a frequency of the duty cycle is selected to cause the body to vibrate, and
wherein the shaft is confined in the body in a manner to exclude axial movement therein.

2. The vibrating apparatus of claim 1, wherein the resilient member is a spring.

3. The vibrating apparatus of claim 1, wherein the body is of a size to be hand held.

4. The vibrating apparatus of claim 1, wherein the hub is operable to rotate less than 360 degrees in the first direction.

5. The vibrating apparatus of claim 1, wherein the hub is operable to rotate less than 180 degrees in the first direction.

6. The vibrating apparatus of claim 1, wherein body comprises an exterior surface and an interior surface with the interior surface defining a volume of the body in which the shaft, the hub and the resilient member are disposed and the hub comprises a first arm and a second arm and an electrically conductive wire wrapped in a first direction around the first arm and wrapped in a second direction around the second arm and the vibrating apparatus further comprises a first permanent magnet and a second permanent magnet coupled to the interior surface of the body.

7. A vibrator comprising:
a housing;
a vibrating apparatus disposed in the housing, the vibrating apparatus comprising:
a body;
a shaft disposed in the body;
a hub disposed in the body and coupled to the shaft; and
a resilient member coupled to the shaft;
a controller disposed in the housing and electrically coupled to the hub,
wherein the controller is operable to generate to a duty cycle of a pulse width and a pulse spacing (off state) to rotate the shaft about a longitudinal axis in a first direction in response to a pulse having the pulse width,
wherein the resilient member is operable to rotate the shaft in a second direction opposite the first direction during a pulse spacing of the duty cycle,
wherein a frequency of the duty cycle is selected to cause the body to vibrate, and
wherein the shaft is confined in the body in a manner to exclude axial movement therein.

8. The vibrator of claim 7, wherein the resilient member is a spring.

9. The vibrator of claim 7, wherein the housing comprises an outer surface of a cylindrical shape having opposite first and second end portions, the first portion being defined by a dome shape.

10. The vibrator of claim 7, wherein the first direction is constant for each pulse width.

11. The vibrator of claim 7, wherein the first direction alternates between one of clockwise and counterclockwise with successive pulse widths.

12. The vibrator of claim 7, further comprising a power source coupled to the hub and the controller.

13. The vibrator of claim 12, wherein the power source comprises a battery disposed in the housing.

14. The vibrator of claim 7, further comprising an electrically conductive coil disposed around a portion of the hub and opposing magnets coupled to an interior surface of the body such that the magnets are between the body and shaft, wherein the controller is electrically coupled to the hub through the electrically conductive coil.

15. The vibrator of claim 7, wherein the pulse width is operable to rotate the shaft less than 180 degrees.

16. A method for vibrating an apparatus using pulse-width modulation, the method comprising:
generating pulses to cause a hub coupled to a shaft in a body of the apparatus to rotate the shaft in a first direction; and
changing a direction of rotation of the shaft to a second direction between pulses,
wherein a duty cycle of the generated pulses is selected to cause the apparatus to vibrate, and
wherein the shaft is confined in the body in a manner to exclude axial movement therein.

17. The method of claim 16, wherein the shaft is coupled to a resilient member and rotating the resilient member generates a load on the resilient member and changing a direction of the rotation of the shaft comprises releasing the load on the resilient member.

18. The method of claim 17, wherein the resilient member is a spring.

19. The method of claim 16, wherein the first direction is constant for each generated pulse.

20. The method of claim 16, wherein the first direction alternates between one of clockwise and counterclockwise with successive generated pulses.

21. The method of claim 16, wherein the duty cycle is a first duty cycle and the method further comprises changing the duty cycle to a second duty cycle.

22. The method of claim 16, wherein generating pulses comprises generating pulses comprising a current frequency and the method further comprises changing the current frequency.
